(19) United States
(12) Patent Application Publication
(10) Pub. No.: US 2015/0057901 A1
(43) Pub. Date: Feb. 26, 2015

(54) DEVICE AND METHOD FOR CONTROLLING POWER TAKE-OFF OPERATION OF A MOTOR VEHICLE

(71) Applicant: SCANIA CV AB, Södertäije (SE)

(72) Inventors: Per Sundholm, Nykvarn (SE); Simon Wretblad, Sodertalje (SE); Magnus Eriksson, Solna (SE)

(21) Appl. No.: 14/384,369

(22) PCT Filed: Mar. 14, 2013
(86) PCT No.: PCT/SE2013/050246

§ 371 Date: Sep. 10, 2014

(30) Foreign Application Priority Data
Mar. 19, 2012 (SE) 1250260-5

(51) Int. Cl. F16D 48/06; B60K 25/06

(52) U.S. Cl. CPC F16D 48/06; B60K 25/06; F16D 2500/10437; F16D 2500/31426; F16D 2500/3144
USPC 701/67

(57) ABSTRACT

A method for controlling power take-off in a motor vehicle (100; 110): the vehicle having a driveline with a clutch configuration (237), automatic gearbox (240), throttle (270) to control engine (230) speed and a power take-off function (220), the method including the steps of: confirming whether operation of the power take-off function (220) is requested; whether the clutch configuration (237) in the driveline is open; and if the operation of the power take-off function (220) is requested and the clutch configuration (237) in the driveline is open, activating (s440) a power take-off mode, in which the clutch configuration (237) is kept in an open position, even if the speed of the engine (230) is changed via the throttle (270).

### TECHNICAL FIELD OF THE INVENTION

The present invention relates to a method for controlling power take-off operation in a motor vehicle. The invention also relates to a computer program product, comprising program code for a computer to implement a method according to the invention. The invention also relates to a device for controlling power take-off operation in a motor vehicle, and a motor vehicle equipped with the device.

### BACKGROUND

Some motor vehicles are equipped with so-called engine power take-off. The engine power take-off may be used to operate a power take-off function such as a hook-lift or a tipper. The driver or operator of the vehicle may operate the power take-off function with a control device intended for this purpose, such as a lever or push-button.

According to known configurations, part of a torque of the engine may be used in a controlled manner to operate a power take-off function. It is advantageous if the speed/number of revolutions of the vehicle's engine may be controlled in order to achieve an improved performance of the power take-off function.

In vehicles with a clutch pedal, this may be achieved by opening the clutch with said clutch pedal and then increasing the speed of the engine with the vehicle's accelerator pedal. Thus, the driver may open a clutch in the vehicle's driveline with the clutch pedal and subsequently regulate the speed of the vehicle engine when operating the power take-off function.

In vehicles that do not have a clutch pedal and that are equipped with a two-pedal system and a so-called AMT gearbox, the control system of the vehicle's driveline may be put in a neutral position manually via an actuator, and the vehicle's engine speed regulated with the accelerator pedal, in order to achieve an improved performance of the power take-off function. However, this means that the driver must perform an extra manoeuvre, which may be perceived as inconvenient and time-consuming in stressful situations. An AMT gearbox is an automatically operated gearbox consisting of one gear set per gear, with gear ratios between the gear sets divided into suitable steps.

In vehicles with an AMT gearbox, control devices are arranged for controlling the engine, clutch and gearbox. In said vehicles with an AMT gearbox, a clutch pedal may not be used, and it is therefore problematic for the driver to operate a power take-off function. In vehicles with an automatic clutch, engine speed may not be controlled freely with the accelerator pedal when in gear, since the clutch automatically closes when the accelerator pedal is pressed down.

JP 2000283189 describes a system comprising a power take-off.

US2006/0183599 describes a system which enables the operation of a vehicle and of a power take-off at different engine speeds.

### SUMMARY OF THE INVENTION

There is a need for the ability to operate power take-off efficiently, without unnecessary manoeuvres and loss of time. Further, there is a need for the possibility of activating and controlling the operation of a power take-off function in a motor vehicle in a more user-friendly way than what is currently offered in vehicles.

One objective of this invention is to provide a novel and advantageous method for controlling power take-off in a motor vehicle.

Another objective of the invention is to provide a novel and advantageous device and a novel and advantageous computer program for controlling power take-off in a motor vehicle.

Yet another objective of the invention is to provide a method, a device and a computer program for achieving user-friendly control of power take-off in a motor vehicle.

Yet another objective of the invention is to provide an alternative method, an alternative device and an alternative computer program for controlling power take-off in a motor vehicle.

These objectives are achieved by a method for controlling power take-off in a motor engine according to claim 1.

According to one aspect of the invention, a method is provided for controlling power take-off in a motor vehicle, comprising a driveline with a clutch configuration, an automatic gearbox, a throttle to control engine speed or torque, as well as a power take-off function. The method may comprise the steps of:
confirming whether operation of said power take-off function is requested;
confirming whether said clutch configuration in said driveline is open; and
in the event that the operation of said power take-off function is requested and said clutch configuration in said driveline is open, activating a power take-off mode entailing that said clutch configuration is kept in an open position, even if the speed of the engine is changed via the throttle.

A simple, intuitive and reliable way for the driver to activate said power take-off mode is thus achieved.

The method may further comprise the step of:
confirming, as another criterion for activating said power take-off mode, whether said power take-off function is active and thus ready for operation.

Inconvenient time delays before the driver is able to start the desired activity, such as tipping of goods with a body work configuration (power take-off function), are avoided.

The method may also include the steps of:
confirming whether operation of said power take-off function is no longer requested;
confirming that said throttle is not activated; and
in the event said power take-off function is no longer requested and said throttle is not activated, de-activating said power take-off mode.

A simple, intuitive and reliable way for the driver to de-activate said power take-off mode is achieved.

The method may further comprise the step of:
confirming, as an alternative criterion for de-activating said power take-off mode, whether said power take-off function is inactive and thus not ready for operation.

A security function may be achieved, reverting to normal mode in the event the power take-off function is de-activated, for example as a consequence of leakage of hydraulic fluid in the power take-off function.

The step involving confirmation of whether operation of said power take-off function is requested may include feeding information about said request to a control device in the vehicle, via a signal from a power take-off control regulating device. This achieves a time-efficient comparison process with respect to the desired activity of the vehicle. It may thus be solidly confirmed whether the driver wishes to drive the vehicle, or whether said power take-off mode should be activated for the efficient operation of the power take-off function, while the engine speed is controlled manually and the clutch configuration is open.

Another aspect of the invention provides for a method where the confirmation of whether operation of said power take-off function is requested comprises—by way of impacting one or several vehicle controls associated with the vehicle's vehicular functions—generating a signal through which information about said request is fed to a control device in the vehicle. The control of the motor vehicle's power take-off becomes very simple, since the existing infrastructure of the vehicle is used instead of connecting an external system and the vehicle's driver may, according to this embodiment and using existing control devices, control the performance of the clutch configuration at his own discretion. The phrase “vehicle controls associated with the vehicle's vehicular functions” means such vehicle controls as are arranged for the operation of the vehicle as a vehicle and not specifically for said power take-off.

Said impacting of the vehicle controls associated with the vehicle's vehicular functions may include impacting of any of a brake pedal for a foot-brake, a handbrake for a parking brake, exhaust brake controls, retarder control, direction indicator, horn and accelerator pedal. These different vehicle controls are easily impacted by a driver of the vehicle, so that the power take-off function may be requested quickly and conveniently. Thus, according to a further development of this embodiment, said impacting of the vehicle controls arranged for the vehicle's vehicular functions may include, in a stationary vehicle and with an open clutch configuration, pressing the vehicle's brake pedal and simultaneously or subsequently pressing the vehicle's accelerator pedal. This is a simple and reliable way of requesting the power take-off function, since no other function in the vehicle requires that the vehicle's accelerator pedal be pressed when or after the brake pedal is pressed.

According to an alternative embodiment, said impacting of the vehicle controls arranged for the vehicle's vehicular functions includes, when the vehicle is stationary and the clutch configuration is open, pressing the accelerator pedal at a speed exceeding a specified threshold speed. Thus, said specified threshold speed is selected at a sufficiently high level to clearly exceed the speed at which a driver may wish to press down the accelerator pedal in order to drive the vehicle, and yet it only exceeds this said speed by so much that when the driver decides to request the power take-off function in this manner, he may easily and reliably press the accelerator pedal at a speed which, with a margin of 50% or more, exceeds said threshold speed.

According to another embodiment of the invention, the confirmation of whether operation of said power take-off function is no longer requested includes—by way of impacting one or several vehicle controls associated with the vehicle's vehicular functions—generating a signal through which information that said power take-off function is no longer requested is fed to a control device in the vehicle. Thus, in the case of said impacting of the vehicle's brake pedal and accelerator pedal for requesting the power take-off function according to one embodiment of the invention, the confirmation of whether operation of the power take-off function is no longer requested may include a release of the brake pedal as well as the accelerator pedal, i.e. cessation of impact of both these pedals. The power take-off function may thus be easily and quickly disconnected, so that by subsequently pressing the accelerator pedal the clutch configuration may be closed and the vehicle may be driven away, if required.

According to one aspect of the invention, a method is provided whereby control of said power take-off operation may take place via control of the engine speed in said activated power take-off mode. This achieves the advantage that a driver may, without manually putting the vehicle's transmission in neutral, automatically and in a user-friendly way, impact the power output from the vehicle's engine for the operation of the power take-off function.

The method is easy to implement in existing motor vehicles. Software for the control of power take-off in a motor vehicle according to the invention may be arranged in a control device of the vehicle when manufactured. A purchaser of the vehicle may thus be afforded the opportunity to choose the performance function as an extra option. Alternatively, software comprising program code to perform the innovative method for controlling power take-off in a motor vehicle may be arranged in a control device of the engine, when upgraded at a service station. In this case, the software is uploaded into a memory in the control device. Implementation of the innovative method is thus cost effective, in particular since no further components need to be arranged in the vehicle according to one aspect of the invention. The required software is currently already arranged in the vehicle. The invention thus provides a cost-efficient solution to the above mentioned problems.

Software comprising program code for controlling power take-off in a motor vehicle may easily be updated or replaced. In addition, different parts of the software which include program code for controlling power take-off operation in a motor vehicle may be replaced independently of each other. This modular configuration is advantageous from a maintenance perspective.

According to one aspect of the invention, a method for controlling power take-off in a motor vehicle is provided, comprising a driveline with a clutch configuration, automatic gearbox, throttle to control engine speed or torque, as well as a power take-off function. The device includes:
elements confirming whether operation of said power take-off function is required;
elements confirming whether said clutch configuration in said driveline is open; and
elements—in the event that the operation of said power take-off function is required and said clutch configuration in said driveline is open—activating a power take-off mode entailing that said clutch configuration is kept in an open position, even if the speed of the engine is changed via the throttle.

The device may also include:
elements confirming whether, as another criterion for activating said power take-off mode, said power take-off function is active and thus ready for operation.

The device may also include:
a power take-off control, which is signal-connected to a control unit in the vehicle, which power take-off control is arranged to provide information including data about said request concerning operation of said power take-off function.

The device may further include elements designed so that they may be impacted to generate a signal, feeding information about said request to a control device in the vehicle, and these elements include one or several vehicle controls arranged for the vehicle's vehicular function. The advantages of using these existing vehicle controls in the vehicle—which are independent of the existence of the device for the power take-off operation—in a device for controlling power take-off operation in a motor vehicle, are set out in the description above of appropriate embodiments of the method according to the invention.

The device may also include:
elements confirming whether operation of said power take-off function is no longer requested;
elements confirming that said throttle is not activated; and
elements de-activating said power take-off mode, in the event said power take-off function is no longer requested and the throttle is not activated.

The device may further include elements arranged so that they may be impacted to generate a signal to feed information that said power take-off function is no longer requested to a control device in the vehicle, and these elements include one or several vehicle controls arranged for the vehicle's vehicular function.

The device may also include:
elements confirming whether, as an alternative criterion for de-activating said power take-off mode, said power take-off function is inactive and thus not ready for operation.

The device may also include elements controlling said power take-off operation based on the speed of the engine in activated power take-off mode.

The above objectives are achieved also with a motor vehicle, comprising special features controlling the power take-off operation of a motor vehicle. The motor vehicle may be a truck or a bus.

According to one aspect of the invention, a computer program is provided for controlling power take-off operation in a motor vehicle, wherein said computer program comprises program code stored in a computer-readable medium in order to cause an electronic control device or another computer connected to the electronic control device to perform the steps according to any of claims 1-12.

According to one aspect of the invention, a computer program is provided for the control of power take-off operation in a motor vehicle, wherein said computer program comprises program code in order to cause an electronic control device or another computer connected to the electronic control device to perform the steps according to any of claims 1-12.

According to one aspect of the invention, a computer program product comprising program code stored in a computer-readable medium is provided to perform the steps according to any of claims 1-12, when said computer program is run in an electronic control unit or in another computer connected to the electronic control unit.

Additional objectives, advantages and novel features of the present invention will be apparent to one skilled in the art from the following details, and through exercising the invention. While the invention is described below, it should be apparent that the invention is not limited to the specifically described details. One skilled in the art, having access to the teachings herein, will recognise additional applications, modifications and incorporations in other areas, which are within the scope of the invention.

### GENERAL DESCRIPTION OF THE DRAWINGS

For a more complete understanding of the present invention and the additional objects and advantages thereof, reference is now made to the following detailed description, which is to be read together with the accompanying drawings, in which the same reference designations pertain to identical parts in the various figures, and in which:

FIG. 1 schematically illustrates a vehicle, according to one embodiment of the invention;

FIG. 2 schematically illustrates a sub-system of the vehicle in FIG. 1, according to one embodiment of the invention;

FIG. 2b shows part of a driver's seat in a vehicle with control devices for the control of the vehicle's vehicular function, which may be used to implement the relevant invention;

FIG. 3a schematically illustrates a functioning mode according to one embodiment of the invention;

FIG. 3b is a diagram illustrating a functioning mode according to one embodiment of the invention;

FIG. 4a schematically illustrates a flow diagram of a method, according to one embodiment of the invention;

FIG. 4b schematically illustrates in more detail a flow diagram of a method, according to one embodiment of the invention;

FIG. 5 schematically illustrates a computer, according to one embodiment of the invention.

### DETAILED DESCRIPTION OF THE FIGURES

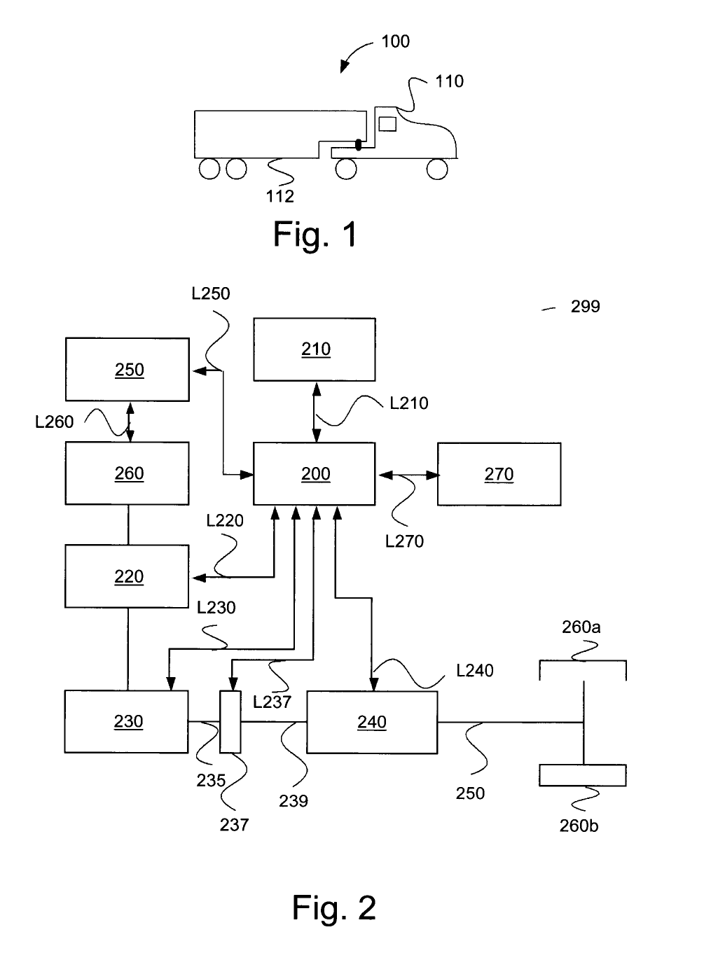

A side view of a vehicle 100 is shown with reference to FIG. 1. The exemplary vehicle 100 consists of a tractor 110 and a trailer 112. The vehicle may be a heavy goods vehicle, such as a truck or a bus.

The term “link” refers herein to a communications link, which may be a physical line such as an opto-electronic communication line, or a non-physical line such as a wireless connection, for example a radio or microwave link.

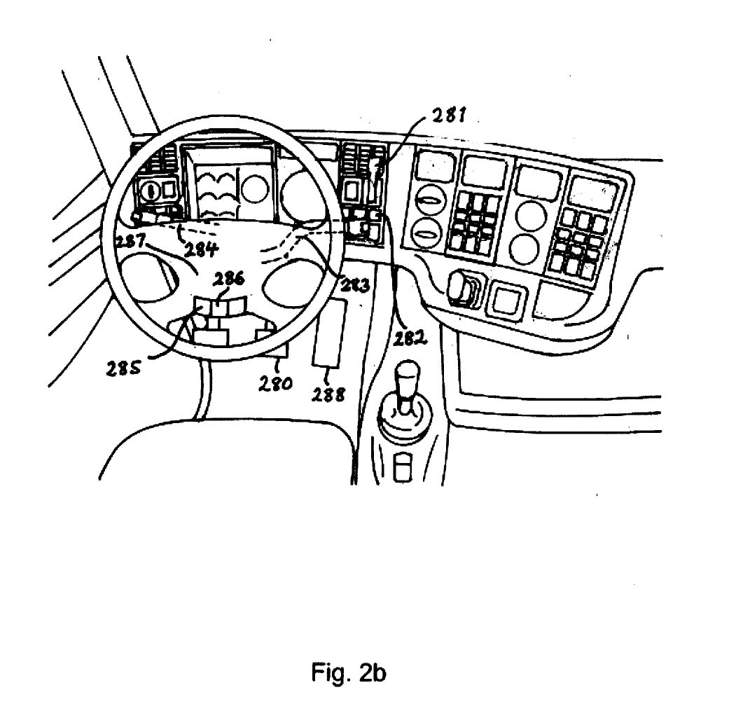

FIG. 2 shows a sub-system 299 in the vehicle 100. Sub-system 299 is arranged in the tractor 110.

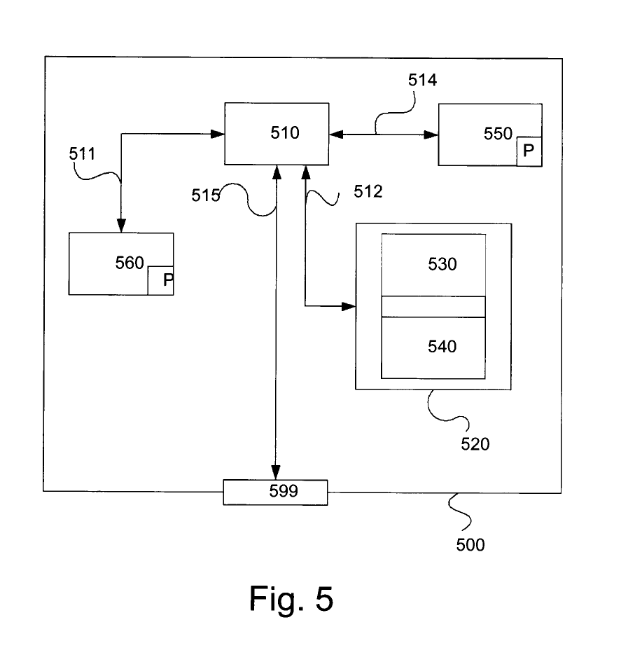

Sub-system 299 comprises a first control device 200. The first control device 200 may comprise a device which is described in further detail with reference to FIG. 5.

Sub-system 299 includes an engine 230. The engine 230 may be a combustion engine. The engine 230 may be a diesel engine with a suitable number of cylinders.

The engine 230 is arranged so as to transmit a generated torque to a clutch configuration 237 via a rotatable shaft 235. The clutch configuration 237 is arranged so as to transmit, in a controlled manner, the torque to an automatic gearbox 240, via a rotatable shaft 239. The clutch configuration 237 may, according to one embodiment, be a multi-plate clutch. The gearbox 240 is arranged so as to transmit a torque via an output shaft 245 to driving wheels 260a and 260b in the vehicle 100.

The first control unit 200 is arranged for communication with the engine 230 via a link L230. The first control unit 200 is arranged so as to control operation in the engine 230 according to control procedures stored in a memory in control unit 200.

The first control unit 200 is arranged for communication with the clutch configuration 237 via a link L237. The first control unit 200 is arranged so as to control operation of the clutch configuration 237 according to control procedures stored in a memory in control unit 200.

The first control unit 200 is arranged for communication with the gearbox 240 via a link L240. The first control unit 200 is arranged so as to control operation of the gearbox 240 according to control procedures stored in a memory in control unit 200.

Manoeuvring elements 250 for operation of a power take-off function 220 are arranged for communication with the first control unit 200 via a link L250. A driver may through the manoeuvring elements 250 activate and control the operation of said power take-off function 220. The manoeuvring elements 250 may include a joystick, control device or push-button, enabling a user-friendly control of said power take-off function 220.

A power take-off function 220 is signal-connected to the first control unit 200 via a link L220. The first control unit 200 may, based on signals received from the manoeuvring elements 250, control the operation of the power take-off function 220. The power take-off function 220 may be any suitable power take-off function 220. According to one embodiment, the power take-off function 220 includes a hook changer. According to another embodiment, the power take-off function 220 includes a tipper.

Said manoeuvring elements 250 are also connected by signal to a valve device 260 via a link L260. Said valve device 260 may be a hydraulic valve to regulate a hydraulic fluid in the power take-off function 220.

The power take-off function 220 may be in an active state and thus ready for operation. This state may comprise a working pressure in the hydraulic fluid of the power take-off function 220. A driver may set the power take-off function 220 in an active state by impacting the valve device 260 via the manoeuvring elements 250.

The power take-off function 220 may alternatively be in an inactive state and thus not ready for operation. This state may comprise a lack of a working pressure in the hydraulic fluid of the power take-off function 220. A driver may continue the power take-off function 220 in an inactive state by impacting the valve device 260 via the manoeuvring elements 250.

The power take-off function 220 may, alternatively, automatically be set in an inactive state and thus not be ready for operation. This inactivation may take place once it is confirmed that there is no longer any working pressure in the hydraulic fluid of the power take-off function 220, such as in the event of a leakage of hydraulic fluid in the power take-off function 220.

The installation 299 comprises a pedal system 270. The pedal system 270 may be a two-pedal system, including a brake pedal and a accelerator pedal.

The pedal system 270 is signal-connected to the first control unit 200 via a link L270. The driver may, via the accelerator pedal, change a prevailing speed in the engine 230. The accelerator pedal may also be referred to as the throttle. According to an alternative embodiment, a driver may request acceleration or braking action with alternative suitable devices.

The first control unit 200 is arranged for the control of power take-off in a motor vehicle, comprising a driveline with a clutch configuration, automatic gearbox, throttle to control engine speed and a power take-off function, according to the innovative method. The first control unit 200 is arranged so as to confirm whether operation of said power take-off function is requested.

The first control device 200 is arranged so as to confirm whether said clutch configuration in said driveline is open. The first control device 200 is arranged—in the event that the operation of said power take-off function is requested and said clutch configuration in said driveline is open—to activate a power take-off mode, entailing that said clutch configuration is kept in an open position, even if the speed of the engine is changed via the throttle. The first control device 200 is arranged so as to confirm whether, as another criterion to activate said power take-off mode, said power take-off function is active and thus ready for operation. The first control device 200 is arranged so as to confirm whether operation of said power take-off function is no longer requested;
to confirm that said throttle is not activated; and
in the event said power take-off function is no longer requested and said throttle is not activated, to de-activate said power take-off mode.

According to one aspect of the invention, the first control unit 200 may be arranged so as to confirm whether operation of said power take-off function is requested or no longer requested by interpreting signals generated by the driver of the vehicle impacting one or several of the vehicle's controls for the vehicle's vehicular function. Such vehicle controls which may be designed to be impacted to generate said signal are set out in FIG. 2b, which is a simplified illustration of a part of a driver's seat in a motor vehicle. Such vehicle controls include the brake pedal of the vehicle 280 for a foot-brake, the handbrake 281 for parking brake, exhaust brake lever 282, retarder control device 283, direction indicator lever 284, push-buttons for downhill speed control and cruise control 285 and 286, respectively, horn switch 287 and accelerator pedal 288. By using any or several of these vehicle controls arranged for the vehicle's vehicular function in order to signal that said power take-off function is requested or no longer requested, this is achieved without any requirement for connection of further resources, and these actions are performed in a way that is comfortable for the driver. Thus, the vehicle controls intended for this purpose are designed to generate the relevant signal by such impact thereof, which a driver may not perform when manoeuvring the vehicle as a vehicle. This may entail that the power take-off function is deemed to be requested if the driver, when the vehicle is stationary and the clutch configuration is open, presses the vehicle's brake pedal 280 while simultaneously or subsequently pressing the vehicle's accelerator pedal 288. When both the brake pedal and the accelerator pedal are released, it may be confirmed subsequently that the operation of the power take-off function is no longer requested. There is normally no need to e.g. manoeuvre the retarder lever 283 when the vehicle is stationary and the clutch configuration is open, and therefore it may be used as a possibility for generating a signal, fed to the first control device 200 as information that the vehicle's power take-off function is requested.

The first control unit 200 is arranged to confirm whether, as an alternative criterion for de-activating said power take-off mode, said power take-off function is inactive and thus not ready for operation. The first control unit 200 is arranged to control said power take-off operation based on control of the speed of the engine in said activated power take-off mode.

A second control unit 210 is arranged for communication with the first control unit 200 via a link L210. The second control unit 210 may be detachably connected to the first control unit 200. The second control unit 210 may be a control unit external to the vehicle 100. The second control unit 210 may be arranged to carry out the innovative steps of the method according to the invention. The second control unit 210 may be used to transfer software to the first control unit 200, in particular software to perform the innovative method. Alternatively, the second control unit 210 may be arranged for communication with the first control unit 200 via an internal network in the vehicle. The second control unit 210 may be arranged so as to carry out substantially similar functions as the first control unit 200, e.g., based on signals received, comprising information that the operation of a power take-off function in the vehicle is requested as well as information that a clutch configuration in a driveline of the vehicle is open, and —in the event operation of said power take-off function is requested and said clutch configuration in said driveline is open—activating a power take-off mode entailing that said clutch configuration is maintained open, even if a change of engine speed is requested via the throttle.

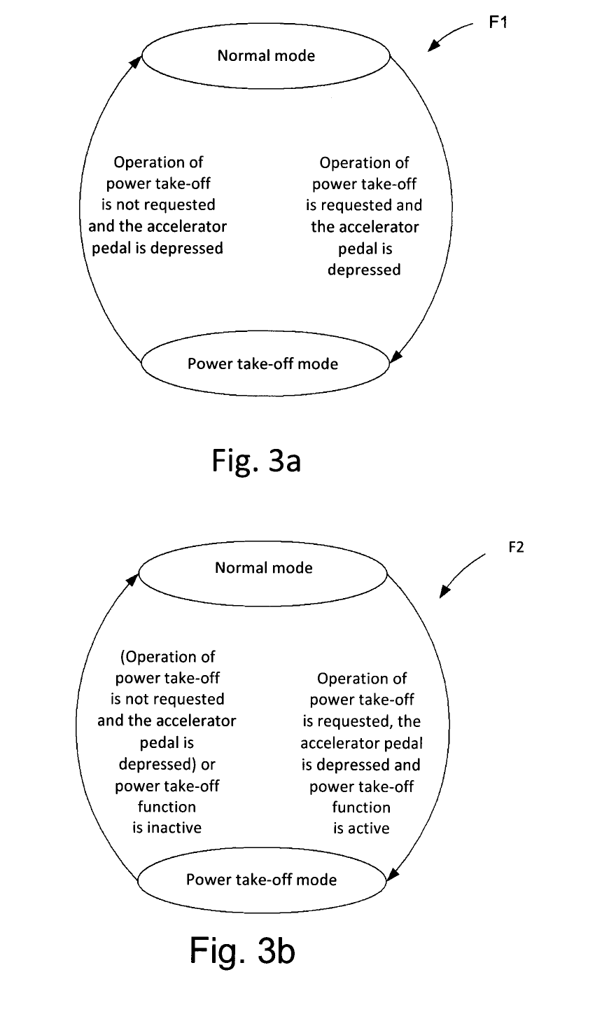

FIG. 3a schematically illustrates a function mode F1 according to one embodiment of the invention.

The function mode F1 is based on a normal mode. In said normal mode, the engine 230, the clutch configuration 237 and the gearbox 240 are controlled according to known, stored procedures. In this mode, the clutch configuration 237 will be wholly or partly (slip condition) closed when the driver presses the accelerator pedal of the vehicle.

According to one aspect of the invention, continuous control of whether the driver first impacts the manoeuvring elements 250, or whether the driver first presses the accelerator pedal, is carried out.

If the driver impacts the manoeuvring elements 250 before the driver presses the accelerator pedal, the driver's intention is confirmed as an intention to use the power take-off function 220, and not to drive the vehicle.

If the driver first impacts the manoeuvring elements 250 and the clutch configuration 237 is completely open, i.e. the driver keeps the accelerator pedal depressed, a power take-off mode will be activated.

In the power take-off mode, said clutch configuration will be maintained open even if the engine speed is changed via the throttle. In this mode, the driver may control the torque and speed request via the accelerator pedal, while the clutch configuration remains completely open. Thus, the power take-off function 220 may be controlled in a user-friendly and efficient manner.

In order to revert to said normal mode, the driver must stop impacting the manoeuvring elements and depress the accelerator pedal. The power take-off mode may thus be de-activated and the normal mode activated.

FIG. 3b schematically illustrates a function mode F2 according to one embodiment of the invention.

The function mode F2 is based on a normal mode. In said normal mode, the engine 230, the clutch configuration 237 and the gearbox 240 are controlled according to known, stored procedures. In this mode, the clutch configuration 237 will be wholly or partly (slip condition) closed when the driver presses the accelerator pedal of the vehicle.

According to one aspect of the invention, continuous control of whether the driver first impacts the manoeuvring elements 250, or whether the driver first presses the accelerator pedal, is carried out. Alternatively, impact of vehicle controls arranged for the vehicle's vehicular function is used to request the power take-off function instead (see above).

If the driver impacts the manoeuvring elements 250 before the driver presses the accelerator pedal, the driver's intention is confirmed as an intention to use the power take-off function 220, and not to drive the vehicle.

If the driver first impacts the manoeuvring elements 250 and the clutch configuration 237 is completely open, i.e. the driver keeps the accelerator pedal depressed, and the power take-off function is active, a power take-off mode will be activated. An active state means, for the purposes hereof, that the power take-off function is ready for operation. In one example, the power take-off function may be ready for operation once a working pressure in the hydraulic fluid has been achieved.

In the power take-off mode, said clutch configuration will be maintained open even if the engine speed is changed via the throttle. In this mode, the driver may control the torque and speed request via the accelerator pedal, while the clutch configuration remains completely open. Thus, the power take-off function 220 may be controlled in a user-friendly and efficient manner.

In order to revert to said normal mode, the driver must stop impacting the manoeuvring elements 250 and depress the accelerator pedal. According to one alternative, the power take-off function must be in an inactive state in order to achieve a return to the normal mode. The power take-off mode may thus be de-activated and the normal mode activated.

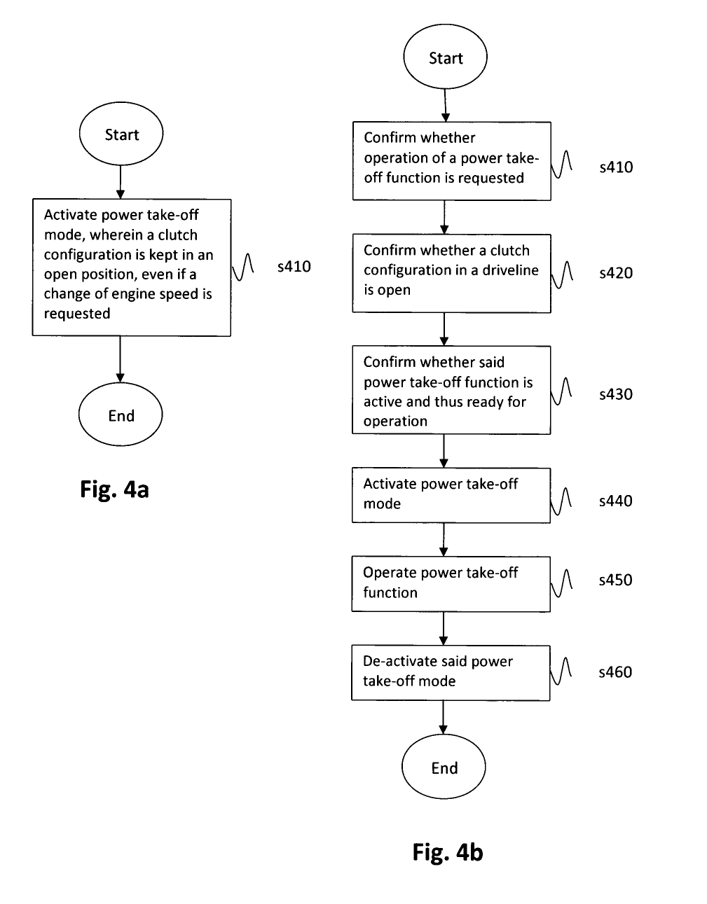

FIG. 4a schematically illustrates a flow diagram of a method for control of power take-off in a motor vehicle, comprising a driveline with a clutch configuration, automatic gearbox, throttle to control engine speed and a power take-off function, according to one embodiment of the invention. The method comprises an initial step of the procedure s401. Step s401 comprises the steps of:
confirming whether operation of said power take-off function is requested;
confirming whether said clutch configuration in said driveline is open; and
in the event that the operation of said power take-off function is required and said clutch configuration in said driveline is open, activating a power take-off mode, entailing that said clutch configuration is kept open even if the speed of the engine is changed via the throttle. The method is completed after step s401.

FIG. 4b schematically illustrates a flow diagram of a method for controlling power take-off in a motor vehicle, comprising a driveline with a clutch configuration, automatic gearbox, throttle to control engine speed and a power take-off function, according to one embodiment of the invention.

The method comprises an initial step of the procedure s410. The method step s410 comprises a step of confirming whether operation of said power take-off function is requested. This may be achieved via manual impact of the manoeuvring elements 250 or vehicle controls for the vehicle's vehicular functions as per the above. Following the method step s410, a subsequent method step s420 is completed.

The method step s420 comprises a step to confirm whether said clutch configuration in said driveline is open. Following the method step s420, a subsequent method step s430 is completed.

The method step s430 comprised a step to confirm whether, as another criterion to activate said power take-off mode, said power take-off function is active and thus ready for operation. Following the method step s430, a subsequent method step s440 is completed.

In the event that the operation of said power take-off function is requested and said clutch configuration in said driveline is open, the method step s440 comprises the step of activating a power take-off mode entailing that said clutch configuration is kept in an open position, even if the speed of the engine is changed via the throttle.

According to an alternative embodiment—in the event the operation of said power take-off function is requested, said clutch configuration in said driveline is open and the power take-off function 220 is active—the step of activating a power take-off mode entailing that said clutch configuration is maintained open even if the engine speed is changed via said throttle is included.

Following the method step s440, a subsequent method step s450 is completed.

The method step s450 comprises a step to operate the power take-off function. This may be achieved by the driver manually requesting a higher speed of the engine 230 via the pedal system 270 (e.g. the accelerator pedal) and impacting the manoeuvring elements 250. Following the method step s450, a subsequent method step s460 is completed.

The method step s460 includes the steps of:
confirming whether operation of said power take-off function is no longer requested;
confirming that said throttle is not activated; and
in the event said power take-off function is no longer requested and said throttle is not activated, de-activating said power take-off mode.

Alternatively, the method step s430 may include the step of:
confirming whether, as an alternative criterion for de-activating said power take-off mode, said power take-off function is inactive and thus not ready for operation.

Following the method step s460, the method is completed.

With reference to FIG. 5, a diagram of an embodiment of system 500 is shown. The control units 200 and 210, which are described with reference to FIG. 2, may in one embodiment comprise the system 500. The systems 500 includes a non-volatile memory 520, a data processing unit 510 and a read/write memory 550. The non-volatile memory 520 has a first memory part 530 wherein a computer program, such as an operative system, is stored to control the function of the system 500. Further, the system 500 includes a bus controller, a serial communications port, an I/O device, an A/D converter, a date-time input and transmission unit, an event counter and an interrupt controller (not displayed). The non-volatile memory 520 also has a second memory part 540.

A computer program P is provided, which may include procedures for control of power take-off in a motor vehicle, comprising a driveline with a clutch configuration, automatic gearbox, throttle to control engine speed and a power take-off function, according to the innovative method. The program P may include procedures to confirm whether operation of said power take-off function is requested. The program P may include procedures to confirm whether said clutch configuration in said driveline is open. The program P may include procedures—in the event that the operation of said power take-off function is requested and said clutch configuration in said driveline is open—to activate a power take-off mode entailing that said clutch configuration is kept in an open position, even if the speed of the engine is changed via the throttle. The program P may include procedures to confirm whether, as another criterion to activate said power take-off mode, said power take-off function is active and thus ready for operation. The program P may include procedures to confirm whether operation of said power take-off function is no longer requested;
to confirm that said throttle is not activated; and
in the event said power take-off function is no longer requested and said throttle is not activated, to de-activate said power take-off mode.

The program P may include procedures confirming whether, as an alternative criterion for de-activating said power take-off mode, said power take-off function is inactive and thus not ready for operation. The program P may also include procedures to control said power take-off operation based on the speed of the engine in said activated power take-off mode.

The program P may be stored in an executable manner or in a compressed manner in a memory 560 and/or a read/write memory 550.

A statement that the data processing unit 510 performs a certain function means that the data processing unit 510 performs a certain part of the program which is stored in the memory 560 or a certain part of the program stored in the read/write memory 550.

The data processing unit 510 may communicate with a data port 599 via a data bus 515. The non-volatile memory 520 is intended for communication with the data processing unit 510 via a data bus 512. The separate memory 560 is intended for communication with the data processing unit 510 via a data bus 511. The read/write memory 550 is arranged to communicate with the data processing unit 510 via a data bus 514. The links L210, L220, L230, L237, L240, L250 and L270, for example, may be connected to the data port 599 (see FIG. 2).

When data is received in the data port 599, it is temporarily stored in the second memory part 540. When in-data received is temporarily stored, the data processing unit 510 is ready to carry out execution of code in the manner described above. According to one embodiment, the signals received by the data port 599 include information on whether operation of said power take-off function has been requested. According to one embodiment, signals received by the data port 599 include information about the position of the throttle in the pedal system 270. The signals received by data port 599 may be used by the system 500 to activate and de-activate a power take-off mode, entailing that a clutch configuration in the engine is maintained open, even if the engine speed is changed via said throttle.

Parts of the methods described herein may be carried out by the system 500 with the help of the data processing unit 510, which runs the program stored in the memory 560 or the read/write memory 550. When the system 500 runs the program, the procedures described herein are executed.

The foregoing description of the preferred embodiments of the present invention has been furnished for illustrative and descriptive purposes. It is not intended to be exhaustive, or to limit the invention to the variants described. Many modifications and variations will obviously be apparent to one skilled in the art. The embodiments have been chosen and described in order to best explicate the principles of the invention and its practical applications, and to thereby enable one skilled in the art to understand the invention in terms of its various embodiments and with the various modifications that are applicable to its intended use.

1. A method for controlling power take-off in a motor vehicle, wherein the motor vehicle comprises an engine, a driveline with a clutch configuration, an automatic gearbox, a throttle to control engine speed and a power take-off function the method comprising:
confirming whether operation of said power take-off function is requested;
confirming whether said clutch configuration in said driveline is open; and
in the event that the operation of said power take-off function is requested and said clutch configuration in said driveline is open, activating a power take-off mode, in which said clutch configuration is kept in an open position even if the speed of the engine is changed via said throttle.

2. The method according to claim 1, further comprising confirming whether said power take-off function is active and thus ready for operation before activating said power take-off mode.

3. The method according to claim 1, further comprising:
confirming whether operation of said power take-off function is no longer requested;
confirming if said throttle is not activated; and
in the event said power take-off function is no longer requested and said throttle is not activated, de-activating said power take-off mode.

4. The method according to claim 3, further comprising confirming whether said power take-off function is inactive and thus not ready for operation as an alternative criterion for de-activating said power take-off mode.

5. The method according to claim 1, wherein said step involving confirmation of whether operation of said power take-off function is requested includes providing information about said request to a control device in the vehicle via a signal from a power take-off control device.

6. The method according to claim 1, wherein the step of confirming whether operation of said power take-off function is requested includes generating a signal through which information is provided about said request to a control device in the vehicle by impacting one or several vehicle controls associated with the vehicle's vehicular functions.

7. The method according to claim 6, wherein said impact of the vehicle controls associated with the vehicle's vehicular functions, includes at least one of impacting either a brake pedal for a foot-brake, a handbrake for a parking brake, exhaust brake controls, a retarder control, a direction indicator, a horn or an accelerator pedal.

8. The method according to claim 7, wherein said impact of the vehicle controls arranged for the vehicle's vehicular functions include, in a stationary vehicle and with open clutch configuration, pressing the vehicle's brake pedal and simultaneously or subsequently pressing the vehicle's accelerator pedal.

9. The method according to claim 7, wherein said impact of the vehicle controls arranged for the vehicle's vehicular functions includes, in a stationary vehicle and with open clutch configuration, pressing the accelerator pedal at a speed exceeding a specified threshold speed.

10. The method according to claim 3, wherein the confirmation of whether operation of said power take-off function is no longer requested includes generating a signal through which information is provided to a control device in the vehicle that said power take-off function is no longer requested by impacting one or several vehicle controls associated with the vehicle's vehicular functions.

11. The method according to claim 8, wherein said steps to confirm whether operation of said power take-off function is no longer requested, includes depressing the brake pedal and the accelerator pedal, i.e. cessation of impact on both these pedals.

12. The method according to claim 1, wherein control of said power take-off operation takes place via control of the engine speed in said activated power take-off mode.

13. A device for the control of power take-off in a motor vehicle wherein the vehicle comprises an engine, a driveline with a clutch configuration, automatic gearbox, a throttle to control engine speed and a power take-off function
first elements to confirm whether operation of said power take-off function is requested;
second elements to confirm whether said clutch configuration of said driveline is open; and
third elements configured such that in the event that the operation of said power take-off function is requested and said clutch configuration in said driveline is open, said third elements activate a power take-off mode, entailing that the clutch configuration is kept in an open position, even if the speed of the engine is changed via said throttle.

14. A device according to claim 13, further comprising:
fourth elements to confirm whether said power take-off function is active and thus ready for operation as another criterion to activate said power take-off mode.

15. A device according to claim 13, further comprising in the vehicle, a power take-off control which is signal-connected to a control unit to provide information, including data about said request concerning operation of said power take-off function.

16. A device according to claim 13, further including fifth elements to be impacted to generate a signal to provide information about said request to a control device in the vehicle, said elements comprising one or several vehicle controls arranged for the vehicle's vehicular function.

17. A device according to claim 13, further comprising:
fifth elements configured to confirm whether operation of said power take-off function is no longer requested;
sixth elements configured to confirm whether said throttle (270) is not activated; and
seventh elements, in the event said power take-off function is no longer requested and said throttle is not activated, to de-activate said power take-off mode.

18. A device according to claim 17, further comprising eighth elements configured to be impacted to generate a signal to provide information about said request to a control device in the vehicle, and said eighth elements comprising one or several vehicle controls arranged for the vehicle's vehicular function.

19. A device according to claim 17, further comprising ninth elements configured to confirm whether, as an alternative criterion for de-activating said power take-off mode, said power take-off function is inactive and thus not ready for operation.

20. A device according to claim 13, further comprising tenth elements to control said power take-off operation based on the speed of the engine in said activated power take-off mode.

21. A motor vehicle, comprising a device according to claim 13.

22. A motor vehicle according to claim 21, wherein the motor vehicle is a truck or a bus.

23. A computer program (P) for control of power take-off in a motor vehicle, wherein the vehicle comprises an engine, a driveline with a clutch configuration, an automatic gearbox, a throttle for control of engine speed and a power take-off function, where said computer program includes program code stored in a non-volatile computer-readable medium to cause an electronic control unit or another computer connected to the electronic control unit to carry out the steps according to claim 1, when said computer program is run in an electronic control unit or in another computer connected to the electronic control unit.

24. (canceled)
